(19) United States
(12) Patent Application Publication
(10) Pub. No.: US 2022/0058099 A1
(43) Pub. Date: Feb. 24, 2022

(54) DEVICE MONITORING SYSTEMS

(71) Applicant: Hewlett-Packard Development Company, L.P., Spring, TX (US)

(72) Inventors: Niranjan Damera Venkata, Chennai (IN); Aravindakshan Babu, Salem (IN); Darrel D Cherry, Boise, ID (US); Anton Wiranata, Boise, ID (US); Prasad Hegde, Bangalore (IN); Mithra Vankipuram, Palo Alto, CA (US)

(73) Assignee: Hewlett-Packard Development Company, L.P., Spring, TX (US)

(21) Appl. No.: 17/311,760

(22) PCT Filed: May 13, 2020
(86) PCT No.: PCT/US2020/032654

§ 371 Date: Jun. 8, 2021

(30) Foreign Application Priority Data
May 16, 2019 (IN) 201941019469

(51) Int. Cl. G06F 11/30; G06F 11/34; G06F 11/07

(52) U.S. Cl. CPC G06F 11/3058; G06F 11/3409; G06F 2201/81; G06F 11/0754; G06F 11/3065

(57) ABSTRACT

A device monitoring system comprising a computation engine to obtain, for each of a plurality of devices, an actual failure condition indicating actual device failure and a probable failure condition predicted by a health monitoring device. The health monitoring device to monitor health of the plurality of devices, the probable failure condition indicating when the device is predicted to stop functioning. The computation engine is to compute a failure prediction gap for each of the plurality of devices. The failure prediction gap indicating a difference between the probable failure condition and the actual failure condition. A performance evaluation engine to compute a saving factor based at least on cost parameters and an average of the failure prediction gap computed for the plurality of devices and initiate discontinuance of usage of the health monitoring device based on a comparison of the saving factor with a threshold.

### BACKGROUND

Device monitoring systems are used to monitor devices for predicting a probable time when the device may fail and stop working. The device monitoring system includes a plurality of health monitoring devices such that each health monitoring device monitors a corresponding device till the device actually fails. The health monitoring device may subsequently start monitoring a replacement device used to replace the device. Usually, the health monitoring device is connected to a remote network such that device parameters, such as temperature, total run time, installation date, and failure time corresponding to the device can be remotely obtained from the device. The health monitoring device may subsequently use the health parameters and a machine learning model to predict the probable time when the device may fail and stop working. Predicting the probable time may facilitate in avoiding last minute delay in service that might occur due to a sudden device failure.

### BRIEF DESCRIPTION OF DRAWINGS

The detailed description is described with reference to the accompanying figures. It should be noted that the description and figures are merely examples of the present subject matter and are not meant to represent the subject matter itself.

FIG. 1 illustrates device monitoring system, according to an example implementation of the present subject matter.

FIG. 2 illustrates a performance evaluator of the device monitoring system, according to an example implementation of the present subject matter.

FIG. 3 illustrates a computing environment having the device monitoring system, according to an example implementation of the present subject matter.

FIG. 4 illustrates a computing environment having the device monitoring system, according to another example implementation of the present subject matter.

FIG. 5 illustrates a method for evaluating performance of a health monitoring device, according to an example implementation of the present subject matter.

FIG. 6 illustrates a method for evaluating performance of a health monitoring device, according to another example implementation of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Device monitoring systems are used to monitor devices for predicting a probable condition, for example, completion of a time period or happening of a specific event, when the device may fail and stop working. Device monitoring systems includes a plurality of health monitoring devices such that each health monitoring device is monitoring a particular device performing a predefined function. The health monitoring devices use gamut of data coming from multiple environments to monitor device health and predict a suitable condition of device malfunction or failure. Further, a health monitoring device may employ various machine learning techniques to intelligently detect a probable failure condition for the device being monitored by the health monitoring device. The health monitoring device may enable downstream cost saving by allowing a planned response to a device's health degradations. In one example, a health monitoring device may monitor a device until the device actually fails and then subsequently starts monitoring a replacement device used to replace the device.

The health monitoring device is connected to a remote network such that device parameters corresponding to the device can be remotely obtained from device. Examples of the devices parameters include, but are not limited to, thermal parameters, such as temperature, heat flux, and dissipation; mechanical parameters, such as friction, pressure, displacement, and torque; electrical parameters, such as voltage, current, and power; chemical parameters; optical parameters; and magnetic parameters, usage data such as total run time, installation date, and failure time. The health monitoring device may subsequently use the device parameters and a machine learning model to predict the probable failure condition when the device may fail and stop working. Predicting the probable failure condition may facilitate in avoiding last minute delay in service that might occur due to a sudden device failure. The probable failure condition may indicate occurrence of a predetermined parameter, such as time, page count, number of use cycles, and happening of a specific event. For instance, the probable failure condition may indicate a probability of failure of the device upon happening of an event indicated by the predetermined parameter, for example, upon completion of 2 months, upon printing of 65 thousand pages, upon completing 10,000 cycles of charging of a battery, etc.

However, the machine learning models used by the health monitoring devices may not always correctly predict the probable failure condition. For instance, the actual failure of a device may occur before the occurrence of the predicted probable failure condition. The user may thus not get enough time to arrange for a replacement device or a maintenance team for replacing the device. The user may thus have to pay extra cost for urgent replacement of the device. In another example, the health monitoring device may predict a probable failure condition to be within a given time window, say 2 months, or on printing of 30,000 pages, while the device may actually fail after, say, a year or after printing 60,000 pages. Thus, if the user replaces the device based on the probable failure condition, the user may incur an opportunity cost of lost utilization of the device by early replacement of a device. Therefore, despite employing the health monitoring device, the user may have to perform manual diagnosis to ensure correct prediction of device failure. The user may further have to incur additional cost owing to incorrect prediction of the device failure time. In such a case, the user may not benefit in terms of cost savings anticipated by employing the health monitoring device.

The present subject matter discloses example implementations of a device monitoring system. The device monitoring system includes a health monitoring device to monitor the health of a device performing a predefined function. Once the device stops functioning due to device failure, the device may be replaced by a replacement device to perform functionalities of the device. The device monitoring system may further include a performance evaluator to evaluate performance of the health monitoring device. In one example, the device monitoring system may estimate whether a failure prediction made by the health monitoring device for the device and each replacement device resulted in a saving for the user to determine whether or not the user may continue using the health monitoring device.

In one example implementation of the present subject matter, the health monitoring device may analyze device parameters of the device to predict the probable failure condition for the device, i.e., the condition, upon happening of which, the device may fail. The probable failure condition may indicate a predetermined parameter, such as time, page count, number of use cycles, and happening of a specific event, occurrence of which may result in failure of a device. Further, once the device is replaced by a replacement device to perform functionalities of the device, the health monitoring system may initiate monitoring of health parameters of the replacement device. The health monitoring system may thus monitor health of each of a plurality of devices sequentially used as a replacement to perform the predefined functionality. In one example, the plurality of devices may include the device and such replacement devices. Further, each of the plurality of devices is sequentially installed in the computing environment, upon device failure of a previously installed device.

Further, the performance evaluator may compute a failure condition gap for each of the plurality of devices based on the probable failure condition and an actual failure condition indicating actual device failure of the device. The failure condition gap may indicate difference between the probable failure condition and the actual failure condition indicating actual device failure. The performance evaluator may subsequently compute an average failure condition gap based on the failure condition gap obtained for the plurality of devices.

The performance evaluator may further compute a saving factor based at least on the average failure condition gap computed for the plurality of devices and cost parameters. In one example, the cost parameters may include a device cost, a repair cost, and an average lifetime value of the devices. In one example, the average lifetime value of a device indicates a maximum condition until when the device is predicted to function after either a first use or manufacture of the device. The average lifetime value may indicate value of a predetermined parameter, such as the time, the page count, the number of use cycles for until when the device may function. The performance evaluator may further compare the saving factor with a threshold to ascertain whether the health monitoring device may be continued to be used or discontinued. The performance evaluator may accordingly render a notification recommending either continuance or discontinuance of the usage of the health monitoring device based on the saving factor.

Further, to increase the saving factor and better the performance of the health monitoring device, the performance evaluator may modify the failure threshold value to an updated failure threshold value. The performance evaluator may subsequently re-compute saving factor using probable failure conditions predicted by the health monitoring device using the updated failure threshold value, actual failure conditions corresponding to the actual device failure of the other plurality of device, and the cost parameters corresponding to the devices.

In one example, the performance evaluator and the health monitoring device may continue re-computing the saving until the re-computed saving factor is equal to a high-performance threshold value. If the re-computed saving factor becomes equal to the high-performance threshold value, the performance evaluator may ascertain the health monitoring device to be efficient and notify the user.

In another example implementation, the performance evaluator may modify various parameters used by the health monitoring device for predicting the probable failure condition. In one example, the performance evaluator may use a proxy, differentiable, utility function that may be defined on historical data to modify the various parameters.

The present subject matter thus facilitates performance evaluation of the health monitoring device based on the savings effected by the health monitoring device. The device monitoring system may thus continue or discontinue usage of the health monitoring device based on the saving factor, thereby savings costs for the user. Thus, the device monitoring system provides a cognitive system that continues to use a health monitoring device if the health monitoring device is functioning effectively to provide saving factor of more than the threshold. Using the average of failure condition gaps as a parameter for determining the saving factor provides an accurate estimate of efficiency of the health monitoring device in comparison to using a single instance of device failure Further, using the average lifetime value as a parameter for determining the saving factor allows the loss owing to early replacement of the device to be considered while computing efficiency and cost of running and using the health monitoring device. Further, modifying the failure threshold value may facilitate in improving the efficiency of the health monitoring device for achieving better results.

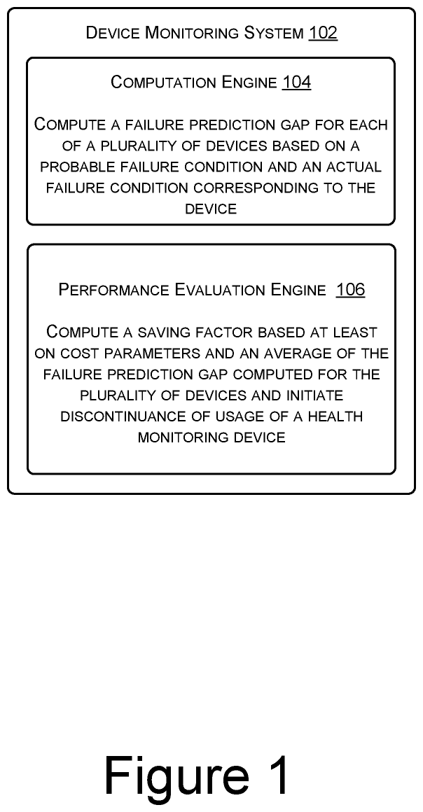

The present subject matter is further described with reference to FIGS. 1 to 6. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a device monitoring system 102, according to an example implementation of the present subject matter. In one example, the device monitoring system 102 may include a health monitoring device (not shown in the figure) to monitor health of a plurality devices (not shown in the figure). In one example, each of the plurality of devices is to sequentially perform a predefined functionality, upon device failure of a previously functioning device. In one example, the device may be a component installed in a system, such as a multifunction printer, a home printer, an office printer, a 3D printer, a scanner, and a photocopy device. In another example, the health monitoring device may monitor the health of the system as a device.

In one example implementation, the device monitoring system 102 may include a computation engine 104 to obtain, for each of the plurality of devices, a probable failure condition predicted by the health monitoring device. The probable failure condition may indicate when the device is predicted to stop functioning. In one example, the probable failure condition may indicate a predetermined parameter, such as time, page count, number of use cycles, and happening of a specific event, occurrence of which may result in failure of a device, owing to which the device may stop functioning. For instance, the probable failure condition may indicate a probability of failure of the device upon happening of an event indicated by the predetermined parameter, for example, upon competition of 1 year, upon printing of 30 thousand pages, upon completing 15,000 cycles of charging of a battery, etc.

The computation engine 104 may further obtain an actual failure condition indicating actual device failure, for each of the plurality of devices. The actual failure condition may indicate when the device stopped functioning in reality leading to a replacement of the device.

The computation engine 104 may further compute a failure prediction gap for each of the plurality of devices. The failure prediction gap for a device may indicate a difference between the probable failure condition and the actual failure condition for the device. In one example, the computation engine 104 may compute the failure prediction gap for plurality of device monitored by the health monitoring device, in a predefined time period.

The device monitoring system 102 further includes a performance evaluation engine 106 to compute a saving factor based at least on an average failure prediction gap computed for the plurality of devices and cost parameters corresponding to the device. The performance evaluation engine 106 may further initiate discontinuance of usage of the health monitoring device based on a comparison of the saving factor with a threshold. In one example, the cost parameters may include a device cost, an average lifetime value of a device, and the failure condition gap for the device.

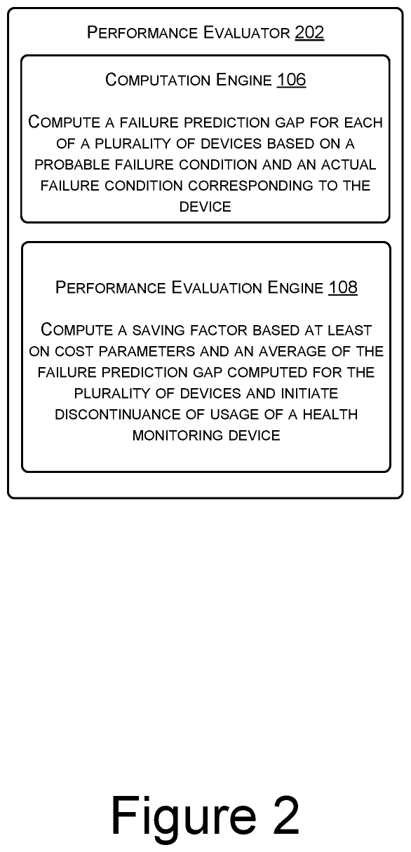

FIG. 2 illustrates a performance evaluator 202 of the device monitoring system 102. In one example, the performance evaluator 202 may be a network server that may be locally or remotely located from the health monitoring device. In one example, the performance evaluator 202 may be virtually located. In another example, the performance evaluator 202 may be implemented using distributed computing.

In one example, the performance evaluator 202 includes the computation engine 104 to obtain an actual failure condition indicating actual device failure, for each of a plurality of devices (not shown in the figure). In one example, each of the plurality of devices is to sequentially perform a predefined functionality, upon device failure of a previously functioning device, in a predefined time period.

The computation engine 104 may further obtain a probable failure condition, for each of the plurality of devices. In one example, the probable failure condition may be predicted by the health monitoring device (not shown in the figure) based on a failure threshold value and device parameters corresponding to the device. As previously indicated, upon occurrence of the probable failure condition the device is predicted to stop functioning due to device failure.

The performance evaluator 202 may further include the performance evaluation engine 106 to determine a saving factor based on cost parameters and the average failure condition gap computed for the plurality of devices. The performance evaluator 202 may further modify the failure threshold value to an updated failure threshold value to increase the saving factor and in turn the efficiency of the health monitoring device. The updated failure threshold value is either numerically greater than the failure threshold value or numerically lesser than the failure threshold value.

Further, the performance evaluation engine 106 may compare the saving factor with a high-performance threshold value. For the saving factor being less than the high-performance threshold value, the performance evaluation engine 106 may iteratively, modify the failure threshold value to the updated failure threshold value and re-compute the saving factor until the re-computed saving factor is equal to the high-performance threshold value.

In one example, the performance evaluation engine 106 may re-compute the saving factor utilizing probable failure conditions predicted by the health monitoring device utilizing the updated failure threshold value for a set of devices, actual failure conditions corresponding to the actual device failure of the set of devices and the cost parameters. In one example, the set of devices may be same as the plurality of devices for which the health monitoring device had initially computed the saving factor. In another example, the set of devices may be another plurality of devices, different from the plurality of devices for which the health monitoring device had initially computed the saving factor.

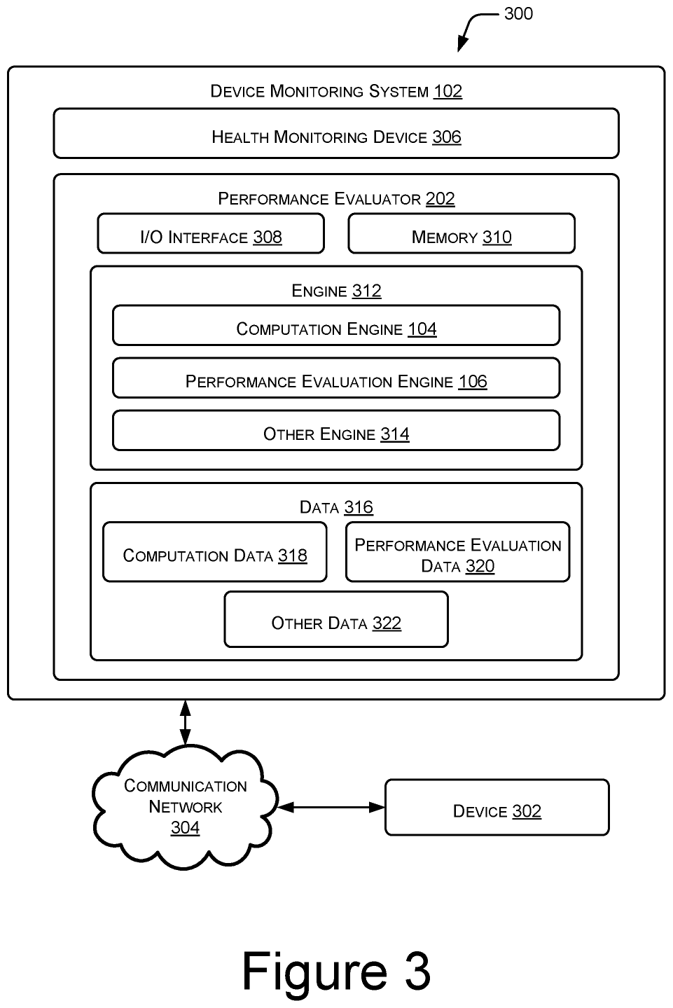

FIG. 3 illustrates a computing environment 300 having the device monitoring system 102, according to an example implementation of the present subject matter. In one example, the computing environment 300 may include a device 302 to perform a predefined functionality. In one example, the device 302 may be an independent system, such as a multifunction printer, a home printer, an office printer, a 3D printer, a scanner, and a photocopy device. In another example, the device 302 may be a component installed in the system to perform the predefined functionality.

Further, upon device failure, i.e., when the device 302 may stop functioning, the device 302 may be replaced by a replacement device as the device 302. The replacement device may subsequently start functioning as the device 302 in place of the previously functioning device 302. Thus, over a predefined time a plurality of devices may be sequentially engaged in the computing environment 300 to sequentially perform a predefined functionality, upon failure of a previously functioning device. In one example, the term engaged may be used herein to refer to installation, utilization, implementation of the device 302 in the computing network 304 or the system. For example, the device 302, such as a print cartridge may be installed in the system, such as a home printer to be engaged in the home printer. In another example, the device 302, such as the home printer may be installed in the system, such as the communication network 304 to be engaged in the communication network.

The device monitoring system 102 and the device 302 may be connected with each other over a communication network 304. The communication network 304 may be a wireless network, a wired network, or a combination thereof. The communication network 304 can also be an individual network or a collection of many such individual networks, interconnected with each other and functioning as a single large network, e.g., the Internet or an intranet. The communication network 304 can be one of the different types of networks, such as intranet, local area network (LAN), wide area network (WAN), and the internet. In an example, the communication network 304 may include any communication network that use any of the commonly used protocols, for example, Hypertext Transfer Protocol (HTTP), and Transmission Control Protocol/Internet Protocol (TCP/IP).

The device monitoring system 102 may include a health monitoring device 306 and the performance evaluator 202 to evaluate performance of the health monitoring device 306. The health monitoring device 306 is to monitor health of the device 302 and the replacement devices sequentially engaged in place of the device 302 to perform the predefined functionality of the device 302. In one example, the health monitoring device 306 may be a network server that may be locally or remotely located from the device 302. In one example, the health monitoring device 306 may be virtually located. In another example, the health monitoring device 306 may be implemented using distributed computing.

The performance evaluator 202 includes input/output (I/O) interface(s) 308 and memory 310. The I/O interface(s) 308 may include a variety of interfaces, for example, interfaces for data input and output devices, referred to as I/O devices, storage devices, network devices, and the like. The I/O interface(s) 308 may facilitate communication between the performance evaluator 202, the health monitoring device 306, the device 302, and various other computing devices connected in a networked environment. The I/O interface(s) 308 may also provide a communication pathway for one or more components of the performance evaluator 202. Examples of such components include, but are not limited to, input device, such as keyboards and a touch enabled graphical user interface.

The memory 310 may store one or more computer-readable instructions, which may be fetched and executed to provide print interfaces to users for providing print instructions. The memory 310 may include any non-transitory computer-readable medium including, for example, volatile memory such as RAM, or non-volatile memory such as EPROM, flash memory, and the like. The device monitoring system device 102 further includes engine(s) 312 and data 316.

The engine(s) 312 may be implemented as a combination of hardware and programming (for example, programmable instructions) to implement one or more functionalities of the engine(s) 312. In examples described herein, such combinations of hardware and programming may be implemented in several different ways. For example, the programming for the engine(s) 312 may be processor executable instructions stored on a non-transitory machine-readable storage medium and the hardware for the engine(s) 312 may include a processing resource (for example, one or more processors), to execute such instructions. In the present examples, the machine-readable storage medium may store instructions that, when executed by the processing resource, implement engine(s) 312. In such examples, the performance evaluator 202 may include the machine-readable storage medium storing the instructions and the processing resource to execute the instructions, or the machine-readable storage medium may be separate but accessible to the performance evaluator 202 and the processing resource. In other examples, engine(s) 312 may be implemented by electronic circuitry. The engine(s) 312 may further include circuitry and hardware for performing print and scan operations. The engine(s) 312 of performance evaluator 202 include the computation engine 104, the performance evaluation engine 106, and other engine(s) 314. The other engine(s) 314 may implement functionalities that supplement applications or functions performed by the engine(s) 312.

The data 316 includes data that is either stored or generated as a result of functionalities implemented by any of the engine(s) 312. The data 316 may include computation data 318, performance evaluation data 320, and other data 322.

As previously described, the health monitoring device 306 may monitor the device 302 to predict a probable failure condition for the device 302. The probable failure condition may be fined as a condition, upon happening of which, the device 302 may fail and thus stop functioning. The probable failure condition may indicate a predetermined parameter, such as time, page count, number of use cycles, and happening of a specific event, occurrence of which may result in failure of the device 302. For instance, the probable failure condition may indicate a probability of failure of the device upon happening of an event indicated by the predetermined parameter, for example, upon competition of 7 months, upon printing of 25 thousand pages, upon completing 8,000 cycles of charging of a battery, etc.

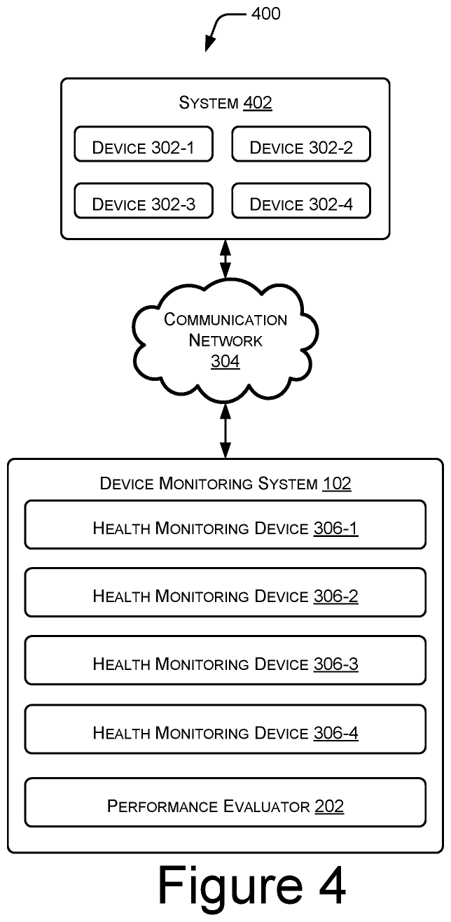

Further, the performance evaluator 202 may estimate whether a failure prediction made by the health monitoring device 306 for the device 302 and each replacement device resulted in a saving for the user to determine whether or not the user may continue using the health monitoring device 306. Further, in one example implementation of the present subject matter, the performance evaluator 202 may monitor and evaluate the performance of multiple health monitoring devices 306, as illustrated in FIG. 4. Each health monitoring device 306, in such a case, many monitor a different device 302, as illustrated in FIG. 4.

In operation, to monitor the health of the device 302, the health monitoring device 306 may obtain device parameters corresponding to the device 302. In one example, the health monitoring device 306 may obtain the device parameters corresponding to the device 302 from the device 302 over the communication network 304. In another example, the health monitoring device 306 may obtain the device parameters corresponding to the device 302 from a central database connected with the device 302. Examples of the devices parameters include, but are not limited to, thermal parameters, such as temperature, heat flux, and dissipation; mechanical parameters, such as friction, pressure, displacement, and torque; electrical parameters, such as voltage, current, and power; chemical parameters; optical parameters; and magnetic parameters, usage data such as total run time, installation date, and failure time.

In one example, the health monitoring device 306 may predict the probable failure condition based on current and past values of the device parameters. Initially, the health monitoring device 306 may analyze the device parameters to predict failure conditions when the device 302 may fail and stop working. In one example, the health monitoring device 306 may utilize a machine learning model to predict the failure conditions. The health monitoring device 306 may subsequently predict the probable failure condition if a failure condition determined exceeds a failure threshold value. The failure threshold value may indicate a maximum operating value that when crossed by a failure condition may result in a device failure. For example, for the device parameter temperature, the failure threshold may be 40 degree Celsius, indicating that if the operating temperature of the device 302 goes beyond 40 degree Celsius, the device may stop working. The health monitoring device 306 may subsequently notify the probable failure condition for the device 302 to a user of the device.

Subsequently, when the device 302 is replaced upon failure, the health monitoring device 306 may initiate monitoring device parameters of the replacement device, from the plurality of devices, sequentially used in the place of the device upon device failure, to perform functionalities of the device. Thus, the health monitoring device 306, may iteratively analyze device parameters of the device 302, predict the probable failure condition for the device 302, and initiate monitoring device parameters of the replacement device.

Further, the health monitoring device 306 may provide the probable failure condition for each of the plurality of devices to the performance evaluator 202. In one example, the probable failure condition may be received by the computation engine 104 of the performance evaluator 202 and saved in the computation data 318 for further processing. The computation engine 104 may further obtain an actual failure condition indicating actual failure of the device and save the actual failure condition in the computation data 318 for further processing. Thus, for each of the plurality of devices 302 monitored by the health monitoring device 306, the computation engine 104 may save the corresponding probable failure condition and the actual failure condition in the computation data 318. Further, the computation engine 104 may save the probable failure condition and the actual failure condition for the plurality of devices 302 monitored in a predefined time, say, 10 months or 5 years. In one example, the predefined time may vary depending on average lifetime of the device 302, such that the performance evaluator 202 has sufficient input for evaluating performance of the health monitoring device 306.

In another example, the computation engine 104 may obtain the probable failure condition and the actual failure condition of the plurality of devices 302 together at the end of the predefined time. The computation engine 104 may obtain the probable failure condition and the actual failure condition from a central database maintaining the record for the device 302.

Subsequently, for each of the plurality of devices, the computation engine 104 may compute a failure prediction gap indicating a difference between the probable failure condition and the actual failure condition indicating actual device failure. The computation engine 104 may calculate a numerical difference between the probable failure condition and the actual failure condition as the failure prediction gap for the device. For instance, if the probable failure condition was predicted to be 2 months and the device 302 failed after 12 months, the computation engine 104 may calculate the failure prediction gap as 10 months, i.e., the difference between the probable failure condition of 2 months and the actual failure condition of 12 months.

The computation engine 104 may further compute an average failure condition gap, i.e., an average of the failure condition gap obtained for the plurality of devices. In one example, the computation engine 104 may calculate a sum of failure condition gaps computed for the plurality of devices to obtain a total failure condition gap. The computation engine 104 may then divide the total failure condition gap by a number of times the predictions of the probable failure conditions are made by the health monitoring device 306.

The computation engine 104 may further determine a residue life cost of the device 302, based on a device cost, an average lifetime of the device 302, and the failure condition gap for the device 302. The residue life cost of the device may be defined as a price value of the device 302 for the failure condition gap. In one example, the residue life cost may indicate a loss that may have been incurred by the user if the device 302 was replaced before the actual failure. In one example, the residue life cost may be computed using the equation (1) given below

residue life cost=(^{C}^{_{P}}/_{L})Δt (1)

, where C_{P} is the device cost, L is the average lifetime of the device 302, and Δt is the failure condition gap for the device 302.

In one example, the average lifetime value of a device indicates a maximum condition until when the device is predicted to function after either a first use or manufacture of the device. The average lifetime value may indicate value of a predetermined parameter, such as the time, the page count, the number of use cycles for until when the device may function. The average lifetime value may be, for example, 3 years from the date of manufacture or first use, 100,000 pages of print, 25,000 use cycles, etc. In one example, the average lifetime value may be indicated by a manufacturer. In another example, the average lifetime value may be computed based on historic data corresponding to similar devices previously used in similar operating conditions.

For example, if an average lifetime of the device 302 is 36 months and the device 302 fails after 24 months, whereas the device 302 was predicted to fail after 20 months, the user may have incurred a loss of 4 months. Further, if the device cost was, say, 3600 in local currency, the user may have incurred the residue life cost of 4000 in the local currency.

The computation engine 104 may further save the residue life cost and the failure condition gap for each of the device 302 in the computation data 318. Subsequently, the performance evaluation engine 106 may compute a saving factor based at least on the average of the failure condition gaps computed for the plurality of devices and cost parameters, i.e., the device cost, a repair cost, and the average lifetime of the device. The repair cost of the device may include a labor cost estimated to be involved in replacing/repairing the device 302. In one example, the saving factor may indicate a notional saving that a user may have made by using the health monitoring device 306 by obtaining the device 302 and arranging for the labor in accordance to the probable failure condition.

In an example, the performance evaluation engine 106 may compute the saving factor using the formula (2) as provided below

$$s = {p}_{r} ( \hat{y} = 1 ) [ 1 - \frac{{C}_{P} + {C}_{l}^{p} + ( {C}_{P} / L ) \overline{Δ t}}{{C}_{P} + {C}_{l}^{u}} ] \qquad ( 2 )$$

where pᵣ(\tilde{y}=1) is a firing rate indicating a probability that a probable failure condition was predicted for the device 302; Δ̅t̅ is the average of the failure condition gaps; Cₗ^{p} is a planned repair cost; Cₗ^{u} is an unplanned repair cost; i.e. the cost associated with an unplanned repair or replacement of the device 302.

The performance evaluation engine 106 may further compare the saving factor with a threshold to ascertain whether the health monitoring device 306 may be continued to be used or discontinued from usage. The threshold may indicate a minimum value of saving factor that may be attained by utilizing the health monitoring device 306. If the saving factor is less than the threshold, the performance evaluation engine 106 may ascertain that the health monitoring device 306 may be discontinued from usage. The performance evaluation engine 106 may further render a notification recommending discontinuance of the usage of the health monitoring device 306. If the saving factor is more than the threshold, the performance evaluation engine 106 may ascertain that the health monitoring device 306 may be continued to be used. The performance evaluation engine 106 may further render a notification recommending continuance of the usage of the health monitoring device 306. In one example, the threshold may be predetermined. In another example, the threshold may be set by the user. The threshold may be, for example, equal to a value of 0%.

Further, if the saving factor is less than a high-performance threshold value, say a value of 30%, the performance evaluation engine 106 may iteratively modify the failure threshold value to an updated failure threshold value and re-compute the saving factor till the saving factor becomes equal to or greater than the high-performance threshold value. In one example, the performance evaluation engine 106 may either increase or decrease the failure threshold value to obtain the updated failure threshold value. Further, the high-performance threshold value may indicate an optimum performance value to be achieved by the health monitoring device 306.

The health monitoring device 306 may subsequently use the updated failure threshold value for predicting probable failure conditions for a set of devices. The computation engine 104 may subsequently re-compute the saving factor using probable failure conditions predicted by the health monitoring device 306 using the updated failure threshold value, actual failure conditions corresponding to the actual device failure condition, the device cost, the repair cost, and a residue life cost of each of the set of devices. In one example, the set of devices may be same as the plurality of devices for which the health monitoring device 306 had initially computed the saving factor. In such a case, the health monitoring device 306 may re-compute the probable failure conditions with the updated failure threshold using historical device parameters data. In another example, the set of devices may be another plurality of devices.

The performance evaluator 202 and the health monitoring device 306 may thus continue to modify the failure threshold value and re-compute the saving factor until the re-computed saving factor is equal to or greater than the high-performance threshold value. Once the re-computed saving factor becomes equal to the high-performance threshold value, the performance evaluator 202 may ascertain the health monitoring device 306 to be efficient and accordingly notify the user.

In another example implementation, the performance evaluator 202 may modify various parameters used by the health monitoring device 306 for predicting the probable failure condition to increase the efficiency of the health monitoring device 306. In one example, the performance evaluator 202 may use a proxy, differentiable, utility function that may be defined on historical data to modify the various parameters.

For instance, for a health monitoring device 306 using sensor data “x” as a device parameter for predicting failure prediction condition, the health monitoring device 306 may use a machine learning model operating on sensor data xₜ, obtained at different time intervals “t”. The health monitoring device 306 may compute a failure probability P(xₜ, θ). The failure probability may indicate estimated probability of the device failing within a threshold window ‘W’ of the current time, with reference to the predicted failure condition. In one example, the probability may be a differentiable function of θ. An example of the machine learning model used by the health monitoring device may include a logistic regression model given by equation (3) below:

$$P ( {x}_{t} , θ ) = \frac{1}{1 + exp ( - {θ}^{T} {x}_{t} )} . \qquad ( 3 )$$

The performance evaluation engine 106 may then compute a loss utility value for a model parameter used by the health monitoring device to compute the probable failure condition. In one example, model parameters may be numeric values to be utilized a machine learning model and may vary for each machine learning model. The performance evaluation engine 106 may then compute the loss utility value based on the failure prediction gap obtained for each of the plurality of devices, the device cost and the repair cost. In one example, the performance evaluation engine 106 may compute the loss utility value using the loss utility function as described in equation (4) below:

$$L ( \{ {T}_{ij} \} , θ ) = {\sum }_{i} {\sum }_{j : {T}_{ij} > W} C ( {T}_{ij} ) ln ( 1 - {p}_{ij} ( {x}_{{t}_{ij}} , θ ) ) + ln [ 1 - {\prod }_{k : {T}_{ik} \leq W} ( 1 - {p}_{ik} ( {x}_{{t}_{ik}} , θ ) ) ] \qquad ( 4 )$$

where i denotes the device 302 being monitored, j denotes the sensor observations for the device 302. xₜ_{ᵢⱼ} is the vector of sensor observations for the i^{th} device 302 at the j^{th} observation time, Tᵢ is the failure prediction gap for the i^{th} device. Further, the utility function L is designed to be higher for a low probability predictions when (Tᵢⱼ>W) from an actual failure and for a high probability predictions close to failure (Tᵢⱼ<=W).

Further, the cost C(Tᵢⱼ) indicates the cost for a particular prediction-failure gap. In one example, the cost C((Tᵢⱼ) may be determined based on the device cost, the repair cost, and the residue life cost of each of the other plurality of devices and may be computed using the equation (5) as provided below:

C(Tᵢⱼ)=Cₚ+Cₗ^{p}+(Cₚ/life)Tᵢⱼ (5)

The performance evaluation engine 106 may then update a value of the model parameter based on the loss utility value to obtain an updated model parameter. As the proxy utility function is differentiable, the parameters θ may be modified to maximize this loss using iterative gradient updates until parameters converge, using the equation (6) as provided below:

θⁱ⁺¹←θⁱ+∇_{θ}L({Tᵢⱼ},θ) (6)

The performance evaluation engine 106 may then provide the updated model parameter to the health monitoring device 306 for predicting the probable failure condition with a better efficiency.

FIG. 4 illustrates a computing environment 400 having the device monitoring system 102 and a system 402, according to another example implementation of the present subject matter. In one example, system 402 may include a first device 302-1, a second device 302-2, a third device 302-3, and a fourth device 302-4. The first device 302-1, the second device 302-2, the third device 302-3, and the fourth device 302-4 are hereinafter collectively referred to as device 302. In one example, each of the device 302 may be installed in the system 402 to perform a predefined functionality. In one example, the system 402 may be an electronic system, such as a multifunction printer, a home printer, an office printer, a 3D printer, a scanner, a photocopy device, a mobile phone, computer, a desktop, and a server. In such a case, the device 302 may be a component installed in the system to perform a predefined functionality. In another example, the system 402 may be a computing environment and the device 302 may be the electronic system, such as a multifunction printer, a home printer, an office printer, a 3D printer, a scanner, a photocopy device, a mobile phone, computer, a desktop, and a server.

Further, the device monitoring system 102 may include multiple health monitoring devices 306 for monitoring the devices 302. In one example, the device monitoring system 102 may include a health monitoring device 306-1 for monitoring the first device 302-1. the device monitoring system 102 may further include a multiple health monitoring device 306-2 for monitoring the second device 302-2, a multiple health monitoring device 306-3 for monitoring the third device 302-3, and a multiple health monitoring device 306-4 for monitoring the fourth device 302-4.

The performance evaluator 202 may individually monitor and evaluate the performance of each of the health monitoring devices 306 in a manner as described while explaining the FIG. 3 above.

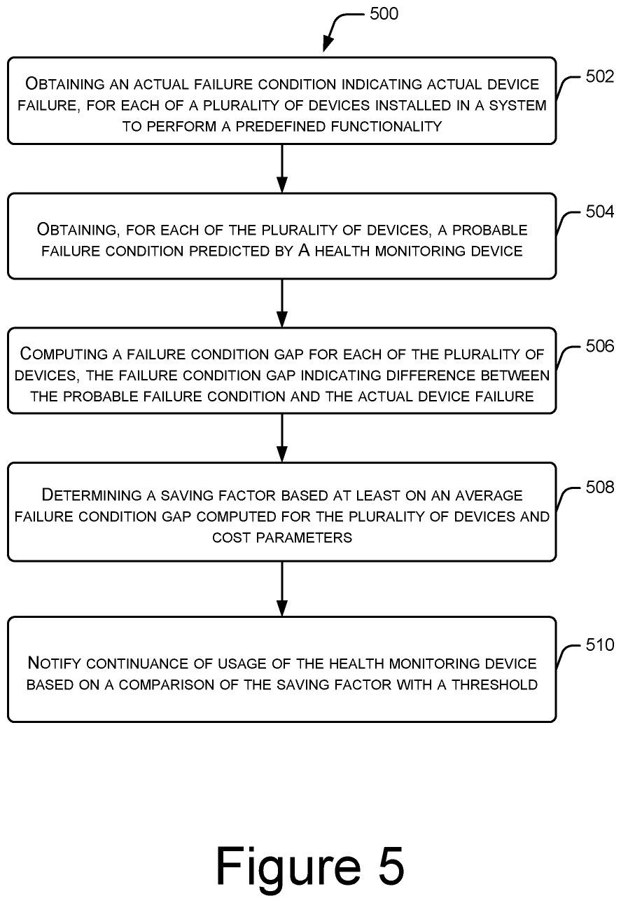

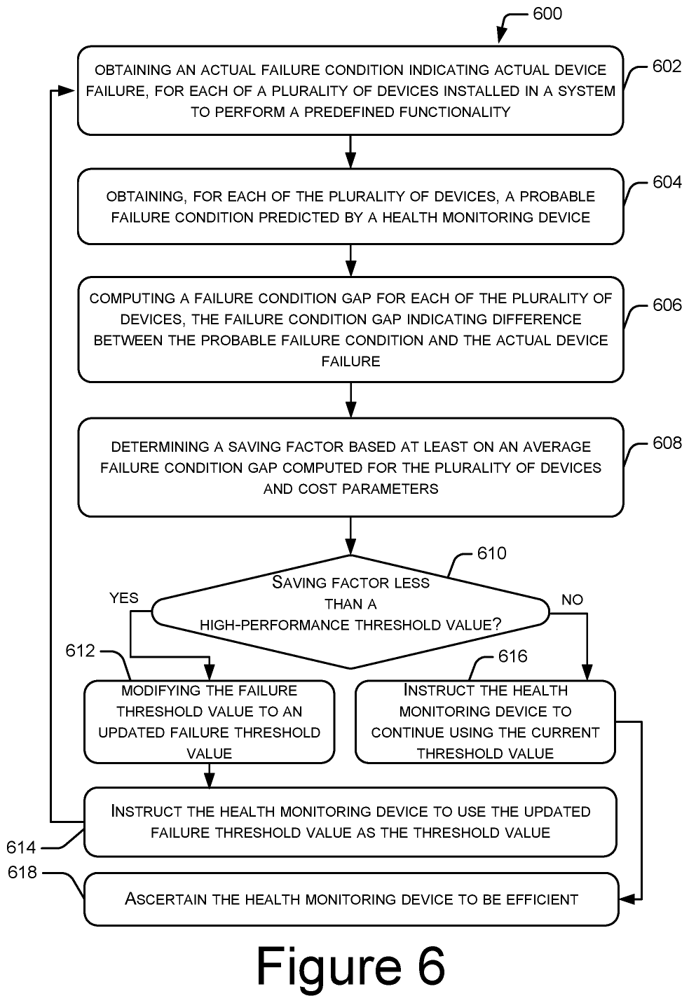

FIGS. 5-6 illustrate example methods 500 and 600, respectively, for evaluating performance of a health monitoring device. The order in which the methods are described is not intended to be construed as a limitation, and any number of the described method blocks may be combined in any order to implement the methods, or an alternative method. Furthermore, methods 500 and 600 may be implemented by processing resource or computing device(s) through any suitable hardware, non-transitory machine readable instructions, or combination thereof.

It may also be understood that methods 500 and 600 may be performed by programmed computing devices, such as the Device monitoring system 102, device 302, as depicted in FIGS. 1-3. Furthermore, the methods 500 and 600 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. The methods 500 and 600 are described below with reference to the device monitoring system 102, and the device 302 as described above; other suitable systems for the execution of these methods may also be utilized. Additionally, implementation of these methods is not limited to such examples.

FIG. 5 illustrates the method 500 for evaluating performance of a health monitoring device, according to an example implementation of the present subject matter. At block 502, an actual failure condition indicating the actual device failure is obtained for each of a plurality of devices. In one example, each of the plurality of devices is to sequentially perform a predefined functionality, upon failure of a previously functioning device. In one example, the device may be a component installed in a system, such as a multifunction printer, a home printer, an office printer, a 3D printer, a scanner, and a photocopy device. In another example, the health monitoring device may monitor the health of the system as a device.

At block 504, a probable failure condition predicted, for each of the plurality of devices, is obtained by the health monitoring device based on a failure threshold value and device parameters corresponding to the device. The probable failure condition indicates a probable condition when the device is predicted to stop functioning due to device failure. In one example, the probable failure condition may indicate a predetermined parameter, such as time, page count, number of use cycles, and happening of a specific event, occurrence of which may result in failure of a device. For instance, the probable failure condition may indicate a probability of failure of the device upon happening of an event indicated by the predetermined parameter, for example, upon completion of 1 year, upon printing of 30 thousand pages, upon completing 15,000 cycles of charging of a battery, etc.

At step 506, a failure condition gap is computed for each of the plurality of devices. The failure condition gap indicates difference between the probable failure condition and the actual device failure. In one example, the computation engine 104 may compute the failure prediction gap for plurality of device monitored by the health monitoring device, in a predefined time period.

At step 508, a saving factor is determined based on cost parameters and an average of the failure condition gap computed for the plurality of devices. In one example, a sum of failure condition gaps computed for the plurality of devices is calculated to obtain a total failure condition gap. The total failure condition gap may be then divided by a number of times the predictions of the probable failure conditions are made by the health monitoring device 306.

At step 510, continuance of usage of the health monitoring device is notified, based on a comparison of the saving factor with a threshold.

FIG. 6 illustrates the method 600 for evaluating performance of a health monitoring device, according to another example implementation of the present subject matter. At block 602, an actual failure condition indicating the actual device failure, for each of the plurality of devices installed in a system to perform a predefined functionality.

At block 604, a probable failure condition predicted, for each of the plurality of devices, is obtained by a health monitoring device based on a failure threshold value and device parameters corresponding to the device. In an example, the probable failure condition may indicate a predetermined parameter, such as time, page count, number of use cycles, and happening of a specific event, occurrence of which may result in failure of a device.

At block 606, a failure condition gap for each of the plurality of devices is computed. The failure condition gap indicates difference between the probable failure condition and the actual failure condition.

At block 608, a saving factor is determined based at least on cost parameters and an average failure condition gap computed for the plurality of devices. In one example, the cost parameters include a device cost, a repair cost, and an average lifetime of the plurality of devices.

At block 610, it is determined whether the saving factor is less than a high-performance threshold value. If, in case it is determined that the saving factor is less than the high-performance threshold value, (‘Yes’ path from block 610), the failure threshold value is modified to an updated failure threshold value at block 612. In one example, the saving factor may indicate a measure of total saving cost when device monitoring system is being used.

At block 614, the health monitoring device is instructed to use the updated failure threshold value. The method may then continue to start from block 602 until a saving factor that is less than a high-performance threshold value is achieved. The method may further proceed to block 616.

In case, it is determined that the saving factor is more than the high-performance threshold value, (‘No’ path from block 610), the health monitoring device is instructed to continue using the threshold value at block 616.

At block 618, the health monitoring device is ascertained to be efficient. In one example, the health monitoring device may notify the user about the efficiency of the health monitoring device.

Although examples for the present subject matter have been described in language specific to structural features and/or methods, it should be understood that the appended claims are not limited to the specific features or methods described. Rather, the specific features and methods are disclosed and explained as examples of the present subject matter.

What is claimed is:

1. A device monitoring system comprising:
a computation engine to:
obtain an actual failure condition indicating actual device failure for each of a plurality of devices;
obtain, for each of the plurality of devices, a probable failure condition predicted by a health monitoring device, the health monitoring device to monitor health of the plurality of devices, the probable failure condition indicating when the device is predicted to stop functioning; and
compute a failure prediction gap for each of the plurality of devices, the failure prediction gap indicating a difference between the probable failure condition and the actual failure condition; and
a performance evaluation engine to:
compute a saving factor based at least on cost parameters and an average of the failure prediction gap computed for the plurality of devices; and
initiate discontinuance of usage of the health monitoring device based on a comparison of the saving factor with a threshold.

2. The device monitoring system as claimed in claim 1, wherein the performance evaluation engine further is to render a notification recommending continuance of the usage of the health monitoring device, for the saving factor being greater than the threshold.

3. The device monitoring system as claimed in claim 1, further comprising the health monitoring device to, iteratively, for each of the plurality of devices, wherein each of the plurality of devices is to sequentially perform a predefined functionality, upon failure of a previously functioning device:
analyze device parameters of the device;
predict the probable failure condition for the device utilizing a machine learning model, a failure threshold value, and device parameters corresponding to the device; and
initiate monitoring device parameters of a replacement device, from the plurality of devices, sequentially used in place of the device upon device failure, to perform functionalities of the device.

4. The device monitoring system as claimed in claim 1, wherein the performance evaluation engine further is to:
iteratively,
modify a failure threshold value to an updated failure threshold value, wherein the updated failure threshold value is one of:
numerically greater than the failure threshold value; and
numerically lesser than the failure threshold value; and
re-compute the saving factor utilizing probable failure conditions predicted by the health monitoring device utilizing at least the updated failure threshold value for another plurality of devices and actual failure conditions corresponding to the other plurality of device,
until the re-computed saving factor is equal to a high-performance threshold value.

5. The device monitoring system as claimed in claim 1, wherein the cost parameters include a device cost, a repair cost, and an average lifetime value of the device.

6. The device monitoring system as claimed in claim 1, wherein the performance evaluation engine further is to:
compute a loss utility value for a model parameter, used by the health monitoring device to compute the probable failure condition, based on the failure prediction gap obtained for each of the plurality of devices, a device cost, a repair cost, and a loss utility function;
update a value of the model parameter based on the loss utility value to obtain an updated model parameter; and
provide the updated model parameter to the health monitoring device for predicting the probable failure condition.

7. A method for evaluating performance of a health monitoring device, the method comprising:
obtaining an actual failure condition indicating actual device failure, for each of a plurality of devices, wherein each of the plurality of devices is to sequentially perform a predefined functionality, upon failure of a previously functioning device;
obtaining, for each of the plurality of devices, a probable failure condition predicted by the health monitoring device, the probable failure condition indicating when the device is predicted to stop functioning;
computing a failure condition gap for each of the plurality of devices, the failure condition gap indicating difference between the probable failure condition and the actual failure condition;
determining a saving factor based on cost parameters and an average of the failure condition gap computed for the plurality of devices; and
notifying continuance of usage of the health monitoring device based on a comparison of the saving factor with a threshold.

8. The method as claimed in claim 7, further comprising:
ascertaining one of continuance and discontinuance of usage of the health monitoring device based on a comparison of the saving factor with the threshold; and
rendering a notification recommending discontinuance of the usage of the health monitoring device, for the saving factor being less than the threshold.

9. The method as claimed in claim 7, further comprising:
for the saving factor less than a high-performance threshold value, iteratively,
modifying a failure threshold value to an updated failure threshold value, wherein the failure threshold value is utilized by the health monitoring device to predict the probable failure condition, wherein the updated failure threshold value is one of:
numerically greater than the failure threshold value; and
numerically lesser than the failure threshold value; and
re-computing the saving factor utilizing updated probable failure conditions predicted by the health monitoring device utilizing the updated failure threshold value for the plurality of devices, actual failure conditions corresponding to plurality of devices, device cost, repair cost, and an average lifetime value of the device; and
for the re-computed saving factor equal to the high-performance threshold value, notifying the health monitoring device as an efficient health monitoring device.

10. The method as claimed in claim 7, wherein the determining the saving factor comprising:
computing the average of the failure condition gap for the plurality of devices, based on the failure condition gap computed for each of the plurality of devices and a number of times the predictions of the probable failure condition are made by the health monitoring device for the plurality of devices.

11. The method as claimed in claim 7, wherein the cost parameters include a device cost, an average lifetime value of a device, and repair cost for the device.

12. A performance evaluator to evaluate performance of a health monitoring device, the performance evaluator comprising:
a computation engine to:
obtain an actual failure condition indicating actual device failure, for each of a plurality of devices, wherein each of the plurality of devices is to sequentially perform a predefined functionality, upon failure of a previously functioning device, in a predefined time period; and
obtain, for each of the plurality of devices, a probable failure condition predicted by the health monitoring device based on a failure threshold value and device parameters corresponding to the device, wherein upon occurrence of the probable failure condition the device is predicted to stop functioning due to device failure; and
a performance evaluation engine to:
determine a saving factor based on cost parameters and an average of failure condition gap computed for the plurality of devices, wherein the average of failure condition gap for a device is computed based on the actual failure condition and probable failure condition computed for device; and
for the saving factor being less than a high-performance threshold value, iteratively,
modify the failure threshold value to an updated failure threshold value, wherein the updated failure threshold value is one of:
numerically greater than the failure threshold value; and
numerically lesser than the failure threshold value; and
re-compute the saving factor using probable failure conditions predicted by the health monitoring device utilizing the updated failure threshold value for a set of devices, actual failure conditions corresponding to the actual device failure of the set of devices, and the cost parameters,
until the re-computed saving factor is equal to the high-performance threshold value.

13. The performance evaluator as claimed in claim 12, wherein the computation engine further is to:
compute, as a failure condition gap for each of the plurality of devices, difference between the probable failure condition and the actual failure condition; and
compute the average of the failure condition gap for the plurality of devices, based on the failure condition gap computed for each of the plurality of devices and a number of times the predictions of the probable failure condition for the plurality of devices are made by the health monitoring device.

14. The performance evaluator as claimed in claim 12, wherein the performance evaluation engine further is to:
render a notification recommending discontinuance of the usage of the health monitoring device, for the saving factor being less than a threshold; and
render a notification recommending continuance of the usage of the health monitoring device, for the saving factor being greater than the threshold.

15. The performance evaluator as claimed in claim 12, wherein the cost parameters include a device cost, an average lifetime value of the device, and a repair cost for the device.
